(19) United States
(12) Patent Application Publication
(10) Pub. No.: US 2024/0402502 A1
(43) Pub. Date: Dec. 5, 2024

(54) Electronic Devices With Optical Assembly Positioning Systems

(71) Applicant: Apple Inc., Cupertino, CA (US)

(72) Inventors: Alexander B von Schulmann, Sunnyvale, CA (US); Matin Seadat Beheshti, Sunnyvale, CA (US); Ivan S Maric, Campbell, CA (US)

(21) Appl. No.: 18/470,313

(22) Filed: Sep. 19, 2023

Related U.S. Application Data
(60) Provisional application No. 63/504,973, filed on May 30, 2023.

(51) Int. Cl. G02B 27/01; G02B 27/00

(52) U.S. Cl. CPC G02B 27/0176; G02B 27/0006; G02B 27/0172; G02B 2027/0192

(57) ABSTRACT

A head-mounted device may include optical assemblies for presenting images to a user. Optical assembly positioning systems may be used to adjust the spacing between the optical assemblies to accommodate different interpupillary distances. The optical assembly positioning systems may have motors and threaded shafts rotated by the motors. Rotation of the shafts moves the optical assemblies along guide rods. The shafts may be protected by dust covers. Slots may be formed in the dust covers so that protruding portions of nuts on the threaded shafts can engage the optical assemblies. In some arrangements, the threaded shafts may be mounted within the guide rods and guide rod slots may be provided in the guide rods so that threaded portions of the optical assemblies can reach the shafts. Dust covers can be provided for the guide rod slots. Wipers may be provided to clean guide rod surfaces.

This application claims the benefit of provisional patent application No. 63/504,973, filed May 30, 2023, which is hereby incorporated by reference herein in its entirety.

### FIELD

This relates generally to electronic devices, and, more particularly, to electronic devices such as head-mounted devices.

### BACKGROUND

Electronic devices have components such as displays and lenses. It can be challenging to adjust such devices for use by different users.

### SUMMARY

A head-mounted device may include optical assemblies for presenting images to a user. Optical assembly positioning systems may be used to adjust the spacing between the optical assemblies. By adjusting the positioning of the optical assemblies in this way, users with different interpupillary distances can be accommodated.

The optical assembly positioning systems may have motors and threaded shafts rotated by the motors. Threads on the shafts engage nuts and/or threaded portions of the optical assemblies, so that rotation of the shafts moves the optical assemblies along guide rods.

The shafts may be protected by dust covers. Slots may be formed in the dust covers so that protruding portions of the nuts on the threaded shafts can engage the optical assemblies. In some arrangements the threaded shafts may be mounted within the guide rods and slots may be provided in the guide rods so that threaded portions of the optical assemblies can reach the shafts. Dust covers can also be provided for these slots. In some embodiments, elastomeric wipers are provided that are coupled to the optical assemblies and that help to clean guide rod surfaces as the optical assemblies are moved along the guide rods.

### BRIEF DESCRIPTION OF THE DRAWINGS

FIG. 1 is a diagram of an illustrative head-mounted device in accordance with an embodiment.

FIG. 2 is a perspective view of an illustrative dust cover for an optical assembly positioner in accordance with an embodiment.

FIG. 3 is a top view of the illustrative dust cover of FIG. 2 in accordance with an embodiment.

FIG. 4 is a diagram of an illustrative optical assembly positioning system with dust bellows in accordance with an embodiment.

FIG. 5 is a cross-sectional side view of illustrative dust bellows in accordance with an embodiment.

FIG. 6 is a cross-sectional side view of an illustrative optical assembly and guide rail with dust bellows in accordance with an embodiment.

FIG. 7 is a cross-sectional side view of an illustrative optical assembly positioning system having a guide rail with a slot cover formed from a portion of an optical assembly in accordance with an embodiment.

FIG. 8 is a top view of an illustrative slot cover formed from a flexible layer of material with accordion folds forming a flat bellows or a rolled up dust cover in accordance with an embodiment.

FIG. 9 is a perspective view of an illustrative continuous rolling dust cover for a slot in accordance with an embodiment.

FIG. 10 is a perspective view of an illustrative dust cover formed from opposing first and second rolled springs in accordance with an embodiment.

FIGS. 11, 12, and 13 are cross-sectional side views of illustrative slot dust covers in accordance with embodiments.

FIG. 14 is a cross-sectional side view of an illustrative guide rail and optical assembly with flexible guide rail wipers in accordance with an embodiment.

### DETAILED DESCRIPTION

Electronic devices such as head-mounted devices may have displays for displaying images and lenses that are used in presenting the images to eye boxes for viewing by a user. Different users have different spacings between their eyes, which are sometimes referred to as interpupillary distances. To accommodate users with different interpupillary distances, a head-mounted device may be provided with movable optical assemblies. During movement of the movable optical assemblies, the movable optical assemblies may be guided on guide rails. Dust prevention structures may be used in reducing or eliminating dust accumulation on the guide rails and/or other optical assembly positioning system components. For example, dust that is pulled through interior regions of an electronic device by cooling fans can be blocked using dust covers, dust blocking bellows, dust slot covers, and/or other dust blocking structures.

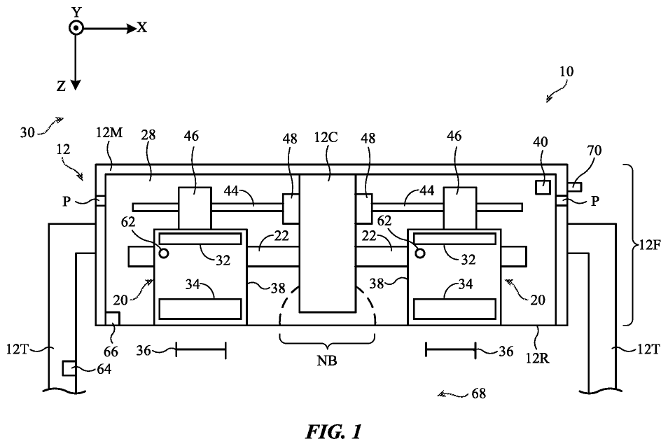

FIG. 1 is a schematic diagram of an illustrative electronic device of the type that may include movable optical assemblies to accommodate different interpupillary distances. Device 10 of FIG. 1 may be a head-mounted device (e.g., goggles, glasses, a helmet, and/or other head-mounted device). In an illustrative configuration, device 10 is a head-mounted device such as a pair of goggles (sometimes referred to as virtual reality goggles, mixed reality goggles, augmented reality glasses, etc.).

As shown in the illustrative cross-sectional top view of device 10 of FIG. 1, device 10 may have a housing such as housing 12 (sometimes referred to as a head-mounted support structure, head-mounted housing, or head-mounted support). Housing 12 may include a front portion such as front portion 12F and a rear portion such as rear portion 12R. When device 10 is worn on the head of a user, rear portion 12R rests against the face of the user and helps block stray light from reaching the eyes of the user and nose bridge portion NB of housing 12 rests on the nose of the user.

Main portion 12M of housing 12 may be attached to head strap 12T. Head strap 12T may be used to help mount main portion 12 on the head and face of a user. Main portion 12M may have a rigid shell formed from housing walls of polymer, glass, metal, and/or other materials. When housing 12 is being worn on the head of a user, the front of housing 12 may face outwardly away from the user, the rear of housing 12 (and rear portion 12R) may face towards the user. In this configuration, rear portion 12R may face the user's eyes located in eye boxes 36.

Device 10 may have electrical and optical components that are used in displaying images to eye boxes 36 when device 10 is being worn. These components may include left and right optical assemblies 20 (sometimes referred to as optical modules). Each optical assembly 20 may have an optical assembly support 38 (sometimes referred to as a lens barrel, optical module support, or support structure) and guide rails 22 along which optical assemblies 20 may slide to adjust optical-assembly-to-optical-assembly separation to accommodate different user interpupillary distances. One or more guide rails 22 may be used to guide each optical assembly. As an example, there may be a set of upper and lower guide rails for the left optical assembly and another set of upper and lower guide rails for the right optical assembly. Guide rails 22 may be formed from hollow tubes (e.g., hollow carbon-fiber tubes or tubes formed from metal, polymer, and/or other material(s)) or other elongated guide members.

Each assembly 20 may have a display 32 that has an array of pixels for displaying images and a lens 34. Lens 34 may optionally have a removable vision correction lens for correcting user vision defects (e.g., refractive errors such as nearsightedness, farsightedness, and/or astigmatism). In each assembly 20, display 32 and lens 34 may be coupled to and supported by support 38. During operation, images displayed by displays 32 may be presented to eye boxes 36 through lenses 34 for viewing by the user.

Rear portion 12R may include flexible structures (e.g., a flexible polymer layer, a flexible fabric layer, etc.) so that portion 12R can stretch to accommodate movement of supports 38 toward and away from each other to accommodate different user interpupillary distances. These flexible portions may sometimes be referred to as a curtain, stretchable fabric curtain, etc.

The walls of housing 12 may separate interior region 28 within device 10 from exterior region 30 surrounding device 10. Housing 12 may have ports P such as air inlets (inlet ports) and air outlets (outlet ports). In interior region 28, optical assemblies 20 may be mounted on guide rails 22. Guide rails 22 may be attached to central housing portion 12C. If desired, the outer ends of guide rails 22 may be unsupported (e.g., the outer end portions of rails 22 may not directly contact housing 12, so that these ends float in interior region 28 with respect to housing 12).

Device 10 may include control circuitry and other components such as components 40. The control circuitry may include storage, processing circuitry formed from one or more microprocessors and/or other circuits. The control circuitry may be used to control any adjustable components 40 in device 10 such as motors, actuators, displays, light-emitting components, audio components, etc. To support communications between device 10 and external equipment, the control circuitry may include wireless communications circuitry. Components 40 may include sensors such as such as force sensors (e.g., strain gauges, capacitive force sensors, resistive force sensors, etc.), audio sensors such as microphones, touch and/or proximity sensors such as capacitive sensors, optical sensors such as optical sensors that emit and detect light, ultrasonic sensors, and/or other touch sensors and/or proximity sensors, monochromatic and color ambient light sensors, image sensors, sensors for detecting position, orientation, and/or motion (e.g., accelerometers, magnetic sensors such as compass sensors, gyroscopes, and/or sensors such as inertial measurement units that contain some or all of these sensors), radio-frequency sensors, depth sensors (e.g., structured light sensors and/or depth sensors based on stereo imaging devices), optical sensors such as self-mixing sensors and light detection and ranging (lidar) sensors that gather time-of-flight measurements, humidity sensors, moisture sensors, visual inertial odometry sensors, current sensors, voltage sensors, and/or other sensors. In some arrangements, devices 10 may use sensors to gather user input (e.g., button press input, touch input, etc.). Sensors may also be used in gathering environmental motion (e.g., device motion measurements, temperature measurements, ambient light readings, etc.).

Displays 32 and other heat-producing components 40 in device 10 may generate heat during operation. To help cool these components, components 40 may include cooling fans that are used to draw air into interior region 28 through air intake vents (e.g., air intakes such as ports P on the upper surface of housing 12 or other portions of device 10). This cooling air may be expelled though corresponding air exit vents (e.g., air outlets such as ports P at the bottom of housing 12). Dust prevention structures in device 10 may be used to prevent cooling air dust from accumulating in undesired locations.

Optical assemblies 20 may have gaze trackers 62 (sometimes referred to as gaze tracker sensors). Gaze trackers 62, which may operate through lenses 34, may include one or more light sources such as infrared light-emitting diodes that emit infrared light to illuminate the eyes of a user in eye boxes 36. Gaze trackers 62 also include infrared cameras for capturing images of the user's eyes and measuring reflections (glints) of infrared light from each of the infrared light sources. By processing these eye images, gaze trackers 62 may track the user's eyes and determine the point-of-gaze of the user. Gaze trackers 62 may also measure the locations of the user's eyes (e.g., the user's eye relief and the user's interpupillary distance).

To accommodate users with different interpupillary distances (eye-to-eye spacings), the spacing between the left and right optical assemblies 20 in device 10 can be adjusted (e.g., to match or nearly match the user's measured interpupillary distance). Device 10 may have left and right actuators such as motors 48. Each motor 48, which may include internal gears, may be used to rotate an elongated threaded shaft (sometimes referred to as a leadscrew or screw) such as shaft 44. A threaded structure that is coupled to each optical assembly is used to engage the threads on shaft 44, so that rotation of shaft 44 moves the optical assembly. In an illustrative configuration, a threaded structure such as nut 46 is provided on each shaft 44. The nut has threads that engage the threads on that shaft 44. When a shaft is rotated, the nut on the shaft is driven in the +X or −X direction (in accordance with whether the shaft is being rotated clockwise or counterclockwise). In turn, this moves the optical assembly 20 that is attached to the nut in the +X or −X direction along its optical assembly guide rail 22. Each assembly 20 (e.g., support 38) may have portions that receive one of guide rails 22 so that the assembly is guided along the guide rail. By controlling the activity of motors 48, the spacing between the left and right optical assemblies of device 10 can be adjusted to accommodate the interpupillary distance of different users. For example, if a user has closely spaced eyes, assemblies 20 may be moved inwardly (towards each other and towards nose bridge portion NB of housing 12) and if a user has widely spaced eyes, assemblies 20 may be moved outwardly (away from each other).

When device 10 is being worn by a user, the user's head is located in region 68. The presence of the user's head (and therefore a determination of whether device 10 is being worn or is unworn) may be made using one or more sensors (e.g., gaze trackers 62, which may detect the presence of the eyes of the user in eye boxes 36, rear-facing sensors such as sensor 66 on main housing 12M, head-facing sensors mounted on strap 12T such as sensor 64, and/or other head presence sensors). These sensors may include cameras, light sensors (e.g., visible light or infrared sensors that measure when ambient light levels have dropped due to shadowing by the head of a user), proximity sensors (e.g., sensors that emit light such as infrared light and that measure corresponding reflected light from a user's head with an infrared light sensor, capacitive proximity sensors, ultrasonic acoustic proximity sensors, etc.), switches and/or other force-sensing sensors that detect head pressure when a user's head is present, and/or other head presence sensors.

Output from head presence sensors and/or output from gaze trackers 62 may be used in controlling motors 48 to automatically adjust the spacing of optical assemblies 20. Optical assembly spacing may also be adjusted manually.

FIG. 2 is a perspective view of an illustrative optical assembly positioning system. In the example of FIG. 2, motor 48 is secured within the interior of housing 12 (e.g., by mounting motor 48 to portions 12C and/or 12M of housing 12 using portion 80P of bracket 80). Bracket 80 may have portions that form dust cover 82 for threaded shaft 44 or the structures that form dust cover 82 may be separate from bracket 80. During operation, shaft 44 is rotated by motor 48. This moves threaded nut 46 laterally (parallel to the X axis of FIG. 2). Pin 46P, which may be attached to nut 46 and/or formed from a portion of a nut 46, may protrude through slot 88 in dust cover 80. Bracket 80 and dust cover 82 may be secured to housing portion 12M using screws 90 or adhesive or other fastening mechanisms.

In the example of FIG. 2, dust cover 82 has frame portion 84 (e.g., a rigid polymer frame) and flexible cover portion 86 (e.g., polymer tape). This is illustrative. One or more pieces of polymer, metal, fabric, and/or other materials may be used in forming a hollow dust blocking structure such as dust cover 82. Dust cover 82 is preferably configured to cover nut 46 and threaded shaft 44 and thereby block dust that might other reach nut 46 and shaft 44. Slot 88 of dust cover 82 is preferably sufficiently long to allow pin 46P to travel back and forth along the X axis (parallel to guide rail(s) 22 of FIG. 1) while adjusting the position of the optical assembly that is coupled to pin 46P. Slot 88 is preferably sufficiently narrow to help prevent dust from entering the interior of dust cover 82. This helps prevent dust from coming into contact with threaded shaft 44. If desired, slot 88 may be covered by a slot cover (sometimes referred to as a slot dust cover). Illustrative slot covers are described in more detail below in the context of slots formed in guide rods 22. In general, device 10 may include any suitable numbers of slot covers and these slot covers may cover slots such as slot 88 in threaded shaft dust covers such as cover 82, may cover slots in guide rods 22, and/or may cover other slots within the structures of device 10 through which dust might pass.

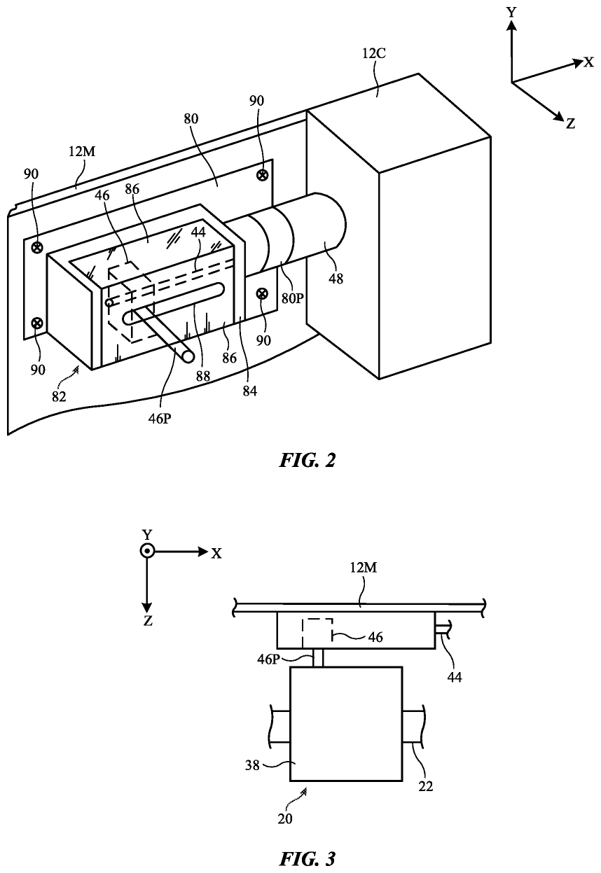

FIG. 3 is a top view of dust cover 82 of FIG. 2 showing how pin 46P may be connected to support structure 38 of optical assembly 20. This allows pin 46P to be used to slide optical assembly 20 along guide rod 22 as threaded shaft 44 rotates and moves nut 46P (to which pin 46P is attached) along the X axis.

In the illustrative arrangement of FIG. 4, threaded shaft 44 is located in the interior of hollow guide rod 22. Guide rod 22 extends along longitudinal axis 94. Rod 22 may be, for example, a hollow cylindrical tube on which support structure 38 of optical assembly slides parallel to the X axis. Threaded shaft 44 may be attached to motor 48 and mounted in alignment with axis 94. Threads on threaded portion 102 of shaft 44 engage corresponding threads on threaded portion 38P of support structure 38 (or threads on a nut coupled to structure 38). During optical assembly positioning operations, motor 48 rotates threaded shaft 44 to move threaded portion 38P of support structure 38 and thereby move support structure 38 and optical assembly 20 parallel to the X axis. Guide rod 22 may have a slot such as slot 100 (sometimes referred to as a guide rod slot) through which portion 38P protrudes and contacts the threads of shaft 44.

To help prevent dust in the interior of device 10 from reaching the surfaces of guide rod 22, dust blocking structures such as tubular bellows 92 may be placed around the outside of guide rod 22. A first section of bellows 92 may cover the lefthand exposed portion of guide rod 22 between motor 48 and the left side of support structure 38 and a second section of bellows 92 may cover the righthand exposed portion of guide rod 22 between the right side of structure 38 and the righthand end of guide rod 22. The ends of guide rod 22 may optionally be provided with end caps 96 to facilitate mounting to portion of housing 12. For example, the left end of guide rod 22 may have an end cap to help attach guide rod 22 to housing portion 12C. The opposing right portion of guide rod 22 may have a floating end cap or may have an end cap that is used to help attach guide rod 22 to housing portion 12M as shown in FIG. 4. Arrangements in which the righthand end cap is omitted (e.g., when the righthand end of guide rod 22 is floating) may also be used. Bellows 92 may extend along axis 94 between attachment points 98. In general, the outermost ends of bellows 22 may be attached to end portions of guide rod 22, end caps 96, housing 12, and/or other suitable structures, whereas the opposing innermost ends of bellows 22 may be attached to support structure 38. Bellows 22 may have accordion folds to accommodate length compression and extension as optical assembly 20 is translated along guide rod 22. Bellows 92 may be formed from fabric, polymer, or other flexible materials.

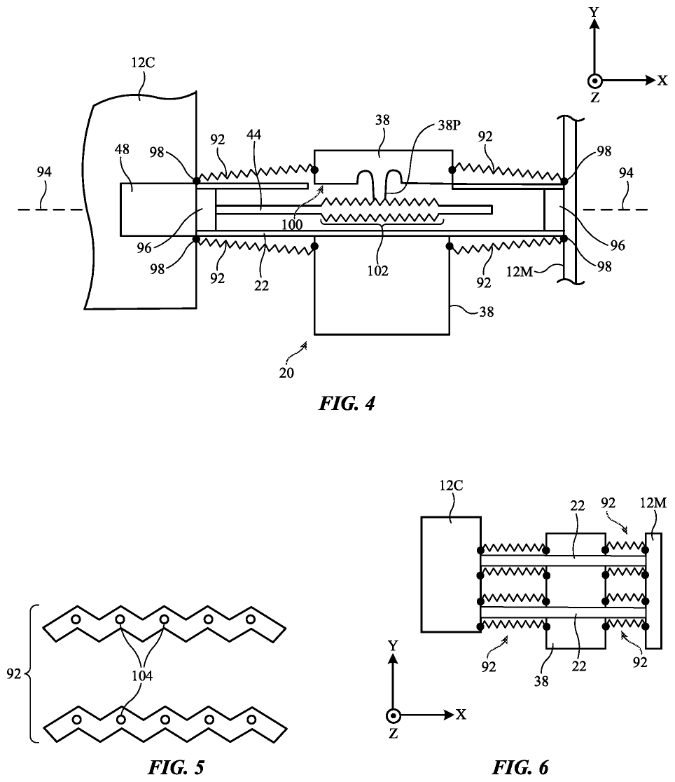

As shown in the cross-sectional side view of FIG. 5, each of bellows 92 may be provided with springs such as spring 104. Springs may be embedded within bellows 92 or mounted on the interior or exterior surface of bellows 92. The spring-force-versus-stretch characteristics of springs 104 may be configured to help counteract centering forces that may develop on optical assembly 20 due to stretching of housing portion 12R as the positions of optical assemblies are adjusted.

If desired, device 10 may have two pairs of guide rods 22. As shown in FIG. 6, for example, each half of device 10 may have an upper guide rod 22 and a corresponding lower guide rod 22 for guiding structure 38. Bellows 92 may be provided on both the upper and lower guide rods. Threaded shafts 44 may be mounted within the upper or lower guide rods or may be mounted outside of the guide rods as described in connection with FIG. 2. Bellows 92 may be used to cover the portions of guide rods 22 that are not within support structures 38.

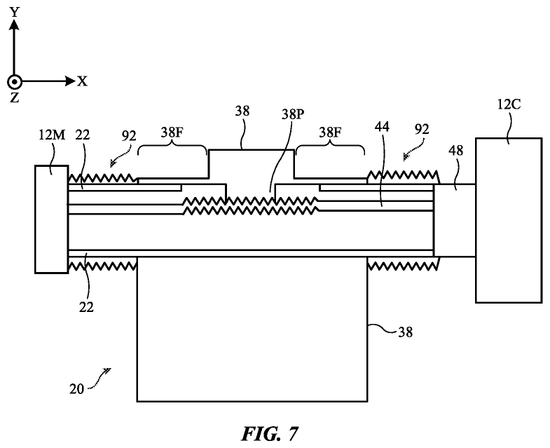

As described in FIG. 4, guide rod 22 may have a slot such as slot 100 through which portion 38P of structure 38 of optical assembly 20 may pass to engaged with threaded shaft 44. To help ensure that dust does not enter the interior of guide rod 22 and thereby come into contact with shaft 44, slot 100 may be provided with a dust cover. In the example of FIG. 7, slot 100 has been provided with a dust cover formed from sliding plates such as sliding plate portions 38F of structure 38. Portions 38F form a dust cover that helps cover slot 100 in guide rod 22. Bellows 92 may be formed from stretchable tubes having accordion folds. Dust blocking structures such as Bellows 92 may surround and cover any exposed portions of guide rods 22. The inner ends of bellows 92 and may be attached to portions 38F. The outer ends of bellows 92 may be attached to guide rod end caps, housing 12, and/or motor 48.

As shown in the top view of FIG. 8, planar accordion-type bellows may be mounted in slot 100 to serve as a slot dust cover (e.g., slot dust cover 82′). Bellows 92′ of FIG. 8 may be formed from accordion-folded sheets of fabric, polymer, or other flexible material. When portion 38P is moved to the right, the bellows 92′ on the right side of slot 100 is compressed and the bellows 92′ on the left side of slot 100 is extended and vice versa. In some embodiments, planar sheets of fabric or flexible polymer that form the left and right sides of slot dust cover 82′. In this type of arrangement, rollers such as rollers 106 may be provided to receive and dispense the dust cover sheets as portion 38P is moved back and forth along the X axis.

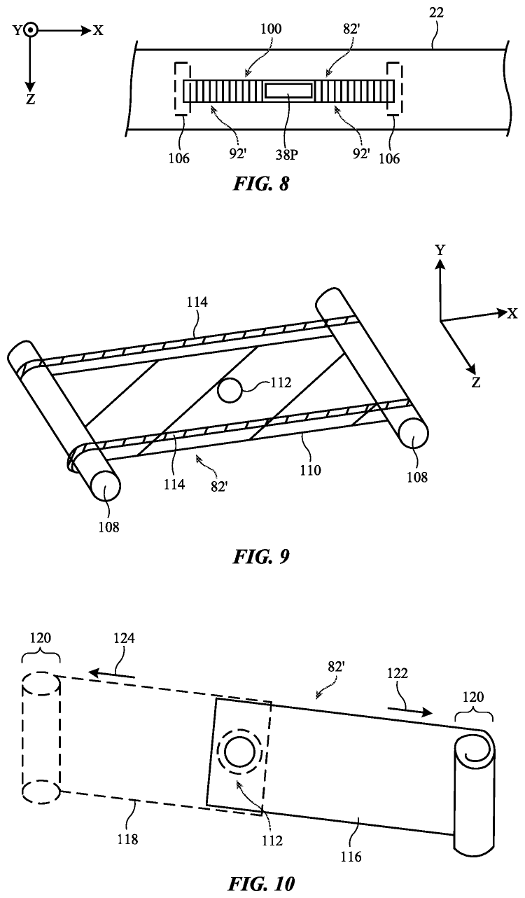

As shown in the perspective view of FIG. 9, slot dust cover 82′ may be formed from a continuous piece of material (e.g., fabric, a flexible polymer sheet, etc.). The pieces of material may be wound around left and right rollers 108. To cover slot 100, dust cover 82′ has a solid piece of fabric or other material such as flexible sheet portion 110 that has an opening such as opening 112. Portion 38P of structure 38 may protrude through opening 112 and slot 100 into the interior of guide rod 22 to engage threaded shaft 44. Narrow portions 114 of cover 82′ help pull sheet portion 110 of cover 82′ back and forth around rollers 108 as structure 38 is repositioned along the X axis.

In the illustrative arrangement of FIG. 10, slot dust cover 82′ has a first portion formed from first spring 116 and an opposing second portion formed from second spring 118. These two portions of cover 82′ are joined together and having overlapping holes forming opening 112. Spring metal or other flexible material may be used in forming springs 116 and 118. Rolled portions 120 of springs 116 and 118 cause springs 116 and 118 to retract. In the example of FIG. 10, the retraction force of spring 116 is directed to the right in direction 122, whereas the retraction force of spring 118 is directed in the opposite direction to the left (direction 124). Accordingly, the spring forces of springs 116 and 118 counteract each other to help minimize any spring forces on portion 38P (which extends through opening 112) as portion 38P is moved along the length of the slot covered by dust cover 82′.

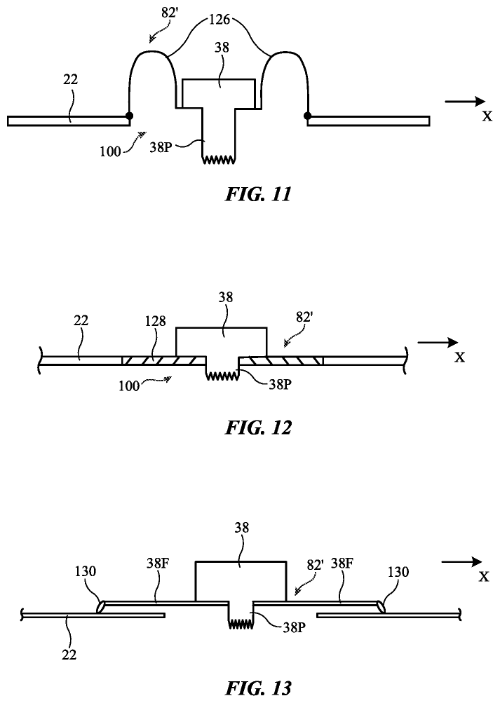

Additional illustrative slot cover arrangements are shown in the cross-sectional side views of FIGS. 11, 12, and 13. In each of these examples, slot 100 has been formed guide rail 22 to allow threaded portion 38P of structure 38 to penetrate into the interior of guide rail 22 (to engage with threaded shaft 44, which is not shown in FIGS. 11, 12, and 13).

In the example of FIG. 11, slot dust cover 82′ has left and right portions 126 formed from folded flexible material (e.g., a bend portion of fabric or a flexible polymer sheet). The bends in portions 126 allow these portions to expand and contract as portion 38P is moved along the X axis.

In the example of FIG. 12, slot dust cover 82′ over slot 100 has been formed from an unbent (planar) sheet of flexible material that is sufficiently pliable to stretch to accommodate movement of portion 38P along the X axis.

In the example of FIG. 13, dust cover 82′ has been formed from planar portions 38F of structure 38 (e.g., plates formed from metal, polymer, and/or other materials) that cover slot 100. The outermost edges of portions 38F may be provided with elastomeric wiper structures such as wipers 130. Wipers 130 may be formed from silicone or other elastomeric polymer. As the position of structure 38P is adjusted along the X axis, wipers 130 may wipe the surfaces of guide rod 22 so that dust is removed from these surfaces. The seals formed between wipers 130 and guide rod 22 may help prevent dust intrusion into the interior of guide rod 22. If desired, the exposed portions of guide rod 22 may be surrounded by an outer tube (with a circular cross-sectional shape, rectangular cross-sectional shape, or other cross-sectional shape) and wipers 130 may bear against this outer tube rather than directly wiping the surface of guide rod 22. In this type of arrangement, dust is prevented from reaching the outer surfaces of guide rod 22.

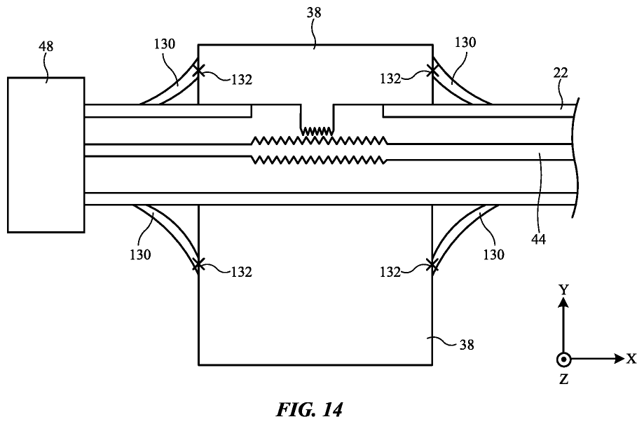

In the illustrative configuration of FIG. 14, wipers 130 are formed from a ring-shaped elastomeric material (e.g., silicone, etc.). Wipers 130 are attached to structure 38 at attachment points 132. This allows portions of wipers 130 that contact guide rod 22 to slide along and clean the surface of guide rod 22 as structure 38 is moved along the X axis. If desired, bellows, outer tubes formed from plates and/or other structures, and/or other dust blocking structures surrounding guide rod 22 may be used as dust covers to cover exposed portions of guide rod 22.

Although sometimes described in connection with guide rod slot dust covers for slots in guide rods 22, slot dust covers such as slot dust cover 82′ may be used to cover any suitable slots in device 10 such as slot 88 in threaded shaft dust cover 82 of FIG. 2.

To help protect the privacy of users, any personal user information that is gathered by device 10 may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. A head-mounted device, comprising:
a head-mounted housing;
guide rods;
optical assemblies in the head-mounted housing that are configured to move towards and away from each other along the guide rods;
nuts coupled to the optical assemblies;
threaded shafts received in the nuts;
motors configured to rotate the threaded shafts to move the nuts and the optical assemblies that are coupled to the nuts; and
dust covers that cover the threaded shafts and the nuts.

2. The head-mounted device defined in claim 1 wherein each dust cover has a dust cover slot, wherein each nut has a protruding portion that protrudes through a respective one of the dust cover slots and is coupled to a respective one of the optical assemblies.

3. The head-mounted device defined in claim 2 wherein the dust covers each have a dust cover frame and tape coupled to the dust cover frame.

4. The head-mounted device defined in claim 2 further comprising a slot dust cover configured to cover the dust cover slot in each dust cover.

5. The head-mounted device defined in claim 1 wherein the dust cover is mounted to the head-mounted housing within an interior region of the head-mounted housing.

6. A head-mounted device, comprising:
a head-mounted housing;
guide rods;
optical assemblies in the head-mounted housing that are configured to move towards and away from each other along the guide rods; and
bellows that cover portions of the guide rods.

7. The head-mounted device defined in claim 6 wherein the bellows comprise tube-shaped bellows that have ends coupled to the optical assemblies.

8. The head-mounted device defined in claim 7 wherein the guide rods comprise hollow guide rods each of which has a slot, the head-mounted device further comprising:
threaded shafts each of which is within a respective one of the hollow guide rods, wherein each optical assembly has a threaded portion that engages a respective one of the threaded shafts through a respective one of the slots.

9. The head-mounted device defined in claim 8 further comprising motors configured to rotate the threaded shafts to move the threaded portions and the optical assemblies that include the threaded portions.

10. The head-mounted device defined in claim 9 further comprising:
slot dust covers, each of which covers a respective one of the slots.

11. The head-mounted device defined in claim 10 wherein the slot dust covers comprise flexible sheets of material configured to be received on rollers.

12. The head-mounted device defined in claim 10 wherein the slot dust covers comprise sheets of material with accordion folds.

13. The head-mounted device defined in claim 10 wherein the slot dust covers comprise plates configured to slide over the slots.

14. The head-mounted device defined in claim 9 further comprising elastomeric wipers coupled to the optical assemblies.

15. The head-mounted device defined in claim 14, wherein the elastomeric wipers are configured to wipe surfaces of the hollow guide rods as the optical assemblies are moved along the guide rods.

16. A head-mounted device, comprising:
a head-mounted housing;
hollow guide rods each of which has a slot; and
optical assemblies in the head-mounted housing that are configured to move towards and away from each other along the hollow guide rods;
threaded shafts each of which is within a respective one of the hollow guide rods, wherein each optical assembly has a threaded portion that engages a respective one of the threaded shafts through a respective one of the slots; and
slot dust covers, wherein each slot dust cover is configured to cover a respective one of the slots.

17. The head-mounted device defined in claim 16 wherein the slot dust covers comprise flexible sheets of material.

18. The head-mounted device defined in claim 16 wherein the slot dust covers comprise sheets of material with accordion folds.

19. The head-mounted device defined in claim 16 wherein the slot dust covers are formed from plate portions of the optical assemblies that are configured to slide over the slots.

20. The head-mounted device defined in claim 16 further comprising elastomeric wipers coupled to the optical assemblies that are configured to wipe surfaces of the hollow guide rods as the optical assemblies are moved along the hollow guide rods.
